(19) United States
(12) Patent Application Publication
(10) Pub. No.: US 2016/0322180 A1
(43) Pub. Date: Nov. 3, 2016

(54) MICROSWITCH KEYBOARD

(71) Applicant: Primax Electronics Ltd., Taipei (TW)

(72) Inventors: CHUANG-SHU JHUANG, Taipei (TW); JIAN-XIN CHEN, Taipei (TW); SHENG-HUANG HUANG, Taipei (TW)

(21) Appl. No.: 14/806,374

(22) Filed: Jul. 22, 2015

(30) Foreign Application Priority Data
Apr. 29, 2015 (CN) 201520269418.2

(51) Int. Cl. H01H 13/85; H01H 13/70

(52) U.S. Cl. CPC H01H 13/85; H01H 13/7013

(57) ABSTRACT

A microswitch keyboard includes a circuit board, a supporting plate and plural keys. Each of the keys includes a keycap, a microswitch element and a connecting element. The supporting plate is disposed on the circuit board. The plural keys are connected with the supporting plate. The microswitch element of each key is disposed under the keycap and connected with the circuit board. The connecting element is disposed under the keycap and arranged around the microswitch element. Moreover, by the connecting element, the keycap is fixed on the supporting plate and guided to be moved upwardly or downwardly relative to the supporting plate. When the keycap is pressed, the microswitch element is triggered to generate a corresponding switch signal.

### FIELD OF THE INVENTION

The present invention relates to a keyboard, and more particularly to a microswitch keyboard.

### BACKGROUND OF THE INVENTION

A keyboard is one of the computer peripheral devices. Generally, the keyboard comprises plural keys. By pressing these keys, input signals or input commands are correspondingly transmitted from the keyboard to the computer.

A membrane keyboard is one of the current keyboards. Conventionally, a membrane keyboard is equipped with scissors-type supporting elements and elastic elements under the keycaps of plural keys. Moreover, a layer of membrane circuit board is disposed under the keys. When one of the keycaps is pressed, the keycap is fixed and stabilized by the scissors-type supporting element. As the keycap is pressed, the elastic element is moved downwardly to trigger the membrane circuit board so as to generate a corresponding signal. Moreover, in response to an elastic force of the elastic element, the pressed keycap is returned to its original position.

However, the membrane keyboard still has some drawbacks. For example, in case that a triggering circuit under a single key is damaged, the whole membrane circuit board has to be replaced with a new one, or even the membrane keyboard is discarded because it is unable to be repaired. In other words, it is unable to replace the single key. Moreover, the use life of pressing the membrane keyboard is short. If the membrane keyboard is frequently operated and the force applied to the membrane keyboard is improper, the membrane keyboard is easily damaged. That is, the expiration rate of the membrane keyboard is high, and it is difficult to maintain the membrane keyboard. Moreover, since the traveling distance of the pressed key is short, the hand feel of pressing the key is usually unsatisfied.

Therefore, there is a need of providing an improved keyboard in order to overcome the above drawbacks.

### SUMMARY OF THE INVENTION

An object of the present invention provides a microswitch keyboard. A single key of the microswitch keyboard can be easily maintained or replaced, and the hand feel of pressing the key can be enhanced.

In accordance with an aspect of the present invention, there is provided a microswitch keyboard. The microswitch keyboard includes a circuit board, a supporting plate and plural keys. The supporting plate is disposed on the circuit board. The plural keys are connected with the supporting plate. Each of the plural keys includes a keycap, a microswitch element and a connecting element. The microswitch element is disposed under the keycap and electrically connected with the circuit board. When the microswitch element is triggered, a corresponding switch signal is generated. The connecting element is disposed under the keycap and arranged around the microswitch element. An upper portion of the connecting element is pivotally coupled to an inner surface of the keycap. A lower portion of the connecting element is pivotally coupled to a top surface of the supporting plate, so that the keycap is fixed on the supporting plate and the keycap is guided to be moved upwardly or downwardly relative to the supporting plate.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the appearance of a microswitch keyboard according to an embodiment of the present invention;

FIG. 2 is a schematic exploded view illustrating a key of the microswitch keyboard according to an embodiment of the present invention; and

FIG. 3 is a schematic assembled view illustrating the key of FIG. 2.

### DETAILED DESCRIPTION OF THE PREFERRED EMBODIMENT

The present invention will now be described more specifically with reference to the following embodiment and accompanying drawings.

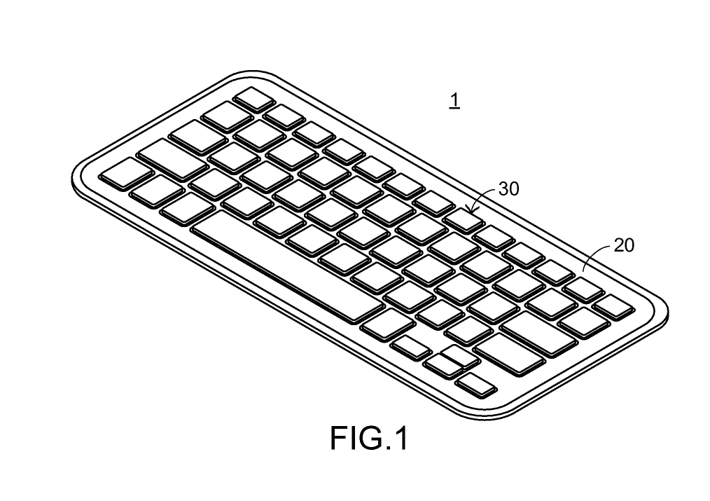

FIG. 1 is a schematic perspective view illustrating the appearance of a microswitch keyboard according to an embodiment of the present invention. As shown in FIG. 1, the microswitch keyboard 1 comprises plural keys 30 and a supporting plate 20. Via the microswitch keyboard 1, the user can input signals and commands. For well understanding the technologies of the present invention, a single key 30 and the associated assembled structure will be illustrated as follows.

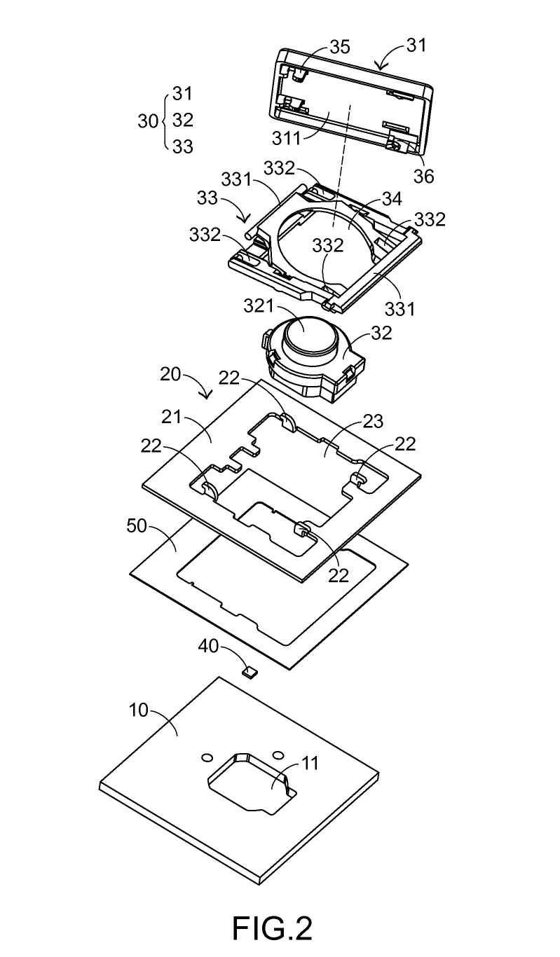

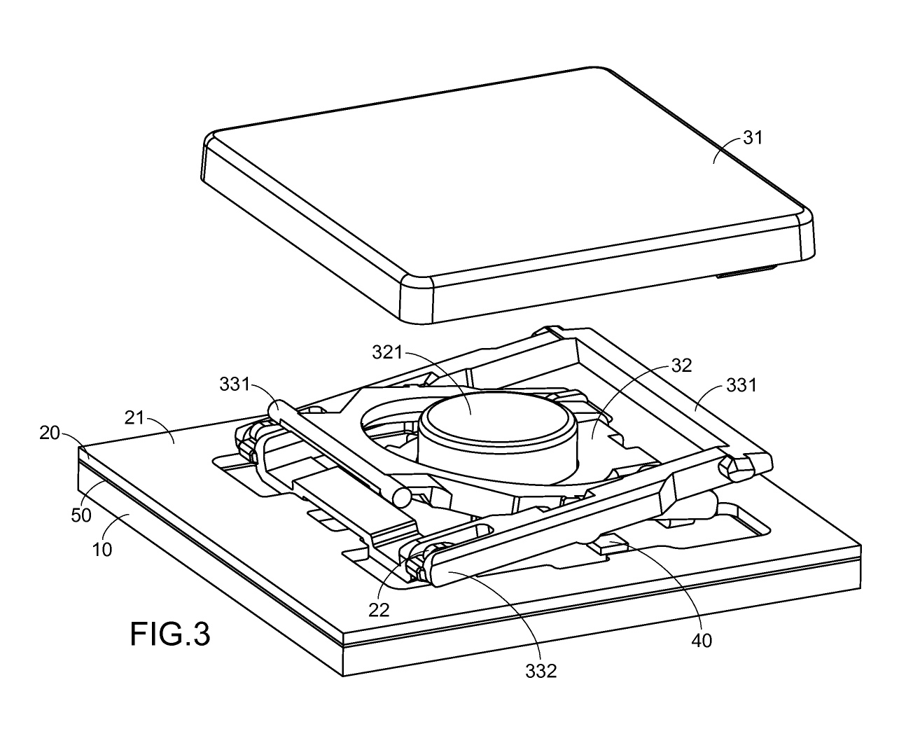

FIG. 2 is a schematic exploded view illustrating a key of the microswitch keyboard according to an embodiment of the present invention. FIG. 3 is a schematic assembled view illustrating the key of FIG. 2. As shown in FIGS. 2 and 3, the microswitch keyboard 1 comprises a circuit board 10, a supporting plate 20, a key 30 and a bonding layer 50. The supporting plate 20 is disposed on the circuit board 10. The key 30 is connected with the supporting plate 20. When the key 30 is pressed, a corresponding switch signal is generated. In particular, the key 30 comprises a keycap 31, a microswitch element 32 and a connecting element 33. The microswitch element 32 is disposed under the keycap 31 and electrically connected with the circuit board 10. The connecting element 33 is disposed under the keycap 31 and arranged around the microswitch element 32. The keycap 31 is connected with the supporting plate 20 through the connecting element 33.

Preferably, the circuit board 10 is a printed circuit board. Moreover, the circuit board 10 has electrical traces (not shown) for transferring the switch signal or command. Moreover, the circuit board 10 further comprises a positioning hole 11 corresponding to the key 30. The microswitch element 32 is embedded within the positioning hole 11. The supporting plate 20 is a flat plate structure. The shape and size of the supporting plate 20 are substantially identical to those of the circuit board 10. The supporting plate 20 is disposed over the circuit board 10. In this embodiment, the supporting plate 20 comprises a top surface 21, plural first hooks 22 and plural openings 23. The supporting plate 20 and the circuit board 10 are combined together through the bonding layer 50, so that the supporting plate 20 and the circuit board 10 are securely fixed on each other. The opening 23 is aligned with the corresponding key 30 and the corresponding positioning hole 11. Moreover, the opening 23 runs through the supporting plate 20 in the vertical direction. The plural first hooks 22 are protruded from the top surface 21 of the supporting plate 20, and respectively located at four corners of the opening 23.

The structure of the key 30 will be illustrated as follows in more details. From the exploded view of FIG. 2, it is found that the keycap 31 has a rectangular cap structure. The keycap 31 can be pressed by the user. Moreover, an inner surface 311 of the keycap 31 is equipped with plural second hooks 35 and plural sliding grooves 36. In this embodiment, the second hooks 35 are formed on an edge of the inner surface 311 at a first side, and the sliding grooves 36 are formed in the inner surface 311 at a second side.

The microswitch element 32 comprises a triggering part 321. When the triggering part 321 is pressed, the microswitch element 32 is triggered to generate the corresponding switch signal. The microswitch element 32 is disposed under the keycap 31, and the triggering part 321 is contacted with the inner surface 311 of the keycap 31. Moreover, the microswitch element 32 is accommodated within the opening 23 of the supporting plate 20 and the positioning hole 11 of the circuit board 10, and electrically connected with the circuit board 10. When the keycap 31 is pressed, the triggering part 321 of the microswitch element 32 is pressed by the inner surface 311 of the keycap 31. Consequently, the microswitch element 32 is triggered to generate the corresponding switch signal. When the keycap 31 is no longer pressed, the triggering part 321 of the microswitch element 32 is automatically restored to its original shape. Consequently, the keycap 31 is returned to its original position where the keycap 31 is not pressed.

For increasing the smoothness of pressing the keycap 31, the microswitch keyboard of the present invention provides the connecting element 33. The connecting element 33 is disposed under the keycap 31. Moreover, the connecting element 33 has a hollow portion 34. The microswitch element 32 is penetrated through the hollow portion 34 and enclosed by the connecting element 33. In this embodiment, the connecting element 33 is a scissors-type connecting element. The connecting element 33 further comprises an upper portion 331 and a lower portion 332. The upper portion 331 and the lower portion 332 are pivotally coupled with each other and movable upwardly or downwardly with respect to the pivotal positions. Consequently, the upper portion 331 and the lower portion 332 can be moved toward or away from each other. Moreover, the upper portion 331 is pivotally coupled to the inner surface 311 of the keycap 31, and the lower portion 332 is pivotally coupled to the top surface 21 of the supporting plate 20. Consequently, the keycap 31 is fixed on the supporting plate 20 and guided to be moved upwardly or downwardly relative to the supporting plate 20. In particular, the upper portion 331 is pivotally coupled to the plural second hooks 35 and the plural sliding grooves 36 at the inner surface 311 of the keycap 31. As shown in FIG. 2, a first end of the upper portion 331 is pivotally coupled to the plural second hooks 35, so that the connecting element is connected with the keycap 31. Moreover, a second end of the upper portion 331 is pivotally coupled to the plural sliding grooves 36, so that the upper portion 331 is slightly moved relative to the keycap 31. Consequently, when the keycap 31 is pressed, the keycap 31 can be smoothly descended. The lower portion 332 is pivotally coupled to the plural first hooks 22 of the supporting plate 20, so that the connecting element 33 is fixed on the supporting plate 20.

As mentioned above, the keycap 31 is connected with the supporting plate 20 through the connecting element 33, and the keycap 31 is movable upwardly or downwardly through the connecting element 33. Furthermore, when the keycap 31 is pressed by an external force, the external force can be uniformly distributed. Consequently, the pressing sensitivity of the microswitch element and the stability of the key are enhanced.

Moreover, for achieving the illuminating efficacy of the microswitch keyboard 1, plural light emitting diodes 40 are disposed within the microswitch keyboard 1. In an embodiment, the plural light emitting diodes 40 are disposed on the circuit board 10, and accommodated within corresponding openings 23 of the supporting plate 20. Consequently, the arrangement of the plural light emitting diodes 40 will not change the original keyboard structure.

From the above descriptions, the present invention provides the microswitch keyboard 1. The keycap 31, the microswitch element 32 and the connecting element 33 of each key 30 are all independent structures. Consequently, if a single key is damaged, the key can be replaced with a new one easily. In comparison with the elastic element of the conventional membrane keyboard, the inherent properties of the microswitch element of the microswitch keyboard of the present invention can provide an obvious hand feel when the corresponding key is pressed. Moreover, the microswitch keyboard 1 further provides the connecting element to alleviate the collision between the keycap 31 and the microswitch element 32 during the pressing process. Moreover, the connecting element can facilitate fix the key and increase the stability of the key. In conclusion, the microswitch keyboard of the present invention can solve the drawbacks of the conventional keyboard.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A microswitch keyboard, comprising:
a circuit board;
a supporting plate disposed on the circuit board; and
plural keys connected with the supporting plate, wherein each of the plural keys comprises a keycap, a microswitch element and a connecting element, wherein the microswitch element is disposed under the keycap and electrically connected with the circuit board, and a corresponding switch signal is generated when the microswitch element is triggered, wherein the connecting element is disposed under the keycap and arranged around the microswitch element, wherein an upper portion of the connecting element is pivotally coupled to an inner surface of the keycap, and a lower portion of the connecting element is pivotally coupled to a top surface of the supporting plate, so that the keycap is fixed on the supporting plate and the keycap is guided to be moved upwardly or downwardly relative to the supporting plate.

2. The microswitch keyboard according to claim 1, wherein the connecting element comprises a hollow portion, and the microswitch element is penetrated through the hollow portion.

3. The microswitch keyboard according to claim 1, wherein the supporting plate further comprises plural first hooks, wherein the plural first hooks are disposed on the top surface of the supporting plate, and the lower portion of the connecting element is pivotally coupled to the plural first hooks.

4. The microswitch keyboard according to claim 1, wherein the key further comprises plural second hooks and plural sliding grooves, wherein the plural second hooks and the plural sliding grooves are located at the inner surface of the keycap, and the upper portion of the connecting element is pivotally coupled to the plural second hooks and the plural sliding grooves.

5. The microswitch keyboard according to claim 1, wherein the supporting plate further comprises plural openings corresponding to the plural keys, wherein the microswitch element is penetrated through the corresponding opening of the supporting plate and contacted with the inner surface of the corresponding keycap.

6. The microswitch keyboard according to claim 5, further comprising plural light emitting diodes, wherein the plural light emitting diodes are disposed on the circuit board and accommodated within the corresponding opening of the supporting plate.

7. The microswitch keyboard according to claim 1, further comprising a bonding layer, wherein the supporting plate and the circuit board are combined together through the bonding layer.

8. The microswitch keyboard according to claim 1, wherein the connecting element is a scissors-type connecting element.

9. The microswitch keyboard according to claim 1, wherein the circuit board further comprises plural positioning holes, wherein each microswitch element is partially accommodated within the corresponding positioning hole.
